(19) United States
(12) Patent Application Publication
(10) Pub. No.: US 2010/0014888 A1
(43) Pub. Date: Jan. 21, 2010

(54) Electrophotographic Photosensitive Member and Image Forming Apparatus Provided with the Same

(75) Inventors: Akihiko Ikeda, Shiga (JP); Daigorou Ookubo, Shiga (JP); Tetsuya Kawakami, Shiga (JP); Takashi Nakamura, Shiga (JP); Masamitsu Sasahara, Shiga (JP); Daisuke Nagahama, Shiga (JP); Tomomi Fukaya, Shiga (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 11/915,717

(22) PCT Filed: May 26, 2006
(86) PCT No.: PCT/JP2006/310594

§ 371 Date: Jul. 30, 2009

(30) Foreign Application Priority Data
May 27, 2005 (JP) 2005-184033

(51) Int. Cl. G03G 15/00; G03G 5/04

(52) U.S. Cl. 399/159; 430/57.1

(57) ABSTRACT

The present invention relates to an electrophotographic photosensitive member 2 including a conductive body 20, a photoconductive layer 22 formed on the conductive body 20 using amorphous silicon, and a surface layer 23 formed on the photoconductive layer using amorphous silicon. The present invention further relates to an image forming apparatus provided with the electrophotographic photosensitive member 2. The photoconductive layer 22 has a mean roughness Ra of not more than 10 nm per 10 μm square. The surface layer 23, without undergoing grinding process, has a mean roughness Ra of not more than 10 nm per 10 μm square.

### TECHNICAL FIELD

The present invention relates to an electrophotographic photosensitive member including a conductive body, and a photoconductive layer and a surface layer formed on the conductive body using at least amorphous silicon. The present invention further relates to an image forming apparatus provided with the electrophotographic photosensitive member.

### BACKGROUND ART

An image forming apparatus such as a copying machine and a printer utilizing electrophotographic method is provided with an electrophotographic photosensitive member for forming electrostatic latent images and toner images. The electrophotographic photosensitive member is required to have electrophotographic property such as potential characteristic (i.e. charging characteristic, optical sensitivity and residual potential) and image characteristic (i.e. density, image resolution, image contrast and image tone) of high quality and stability, as well as durability (against friction, wear, environment and chemical). In order to obtain them, an electrophotographic photosensitive member is suggested to have a conductive body formed with a photoconductive layer on which a surface layer is laminated.

For the surface layer, various materials and structures have been suggested. Amorphous silicon materials (hereinafter referred to as “a-Si”), especially amorphous silicon carbide (hereinafter referred to as “a-SiC”) containing carbon (C) attracts attention as the material of the surface layer that has e.g. high endurance based on high electrical property, high luminous sensitivity, high image property, and high hardness. Further, an electrophotographic photosensitive member provided with a combination of a-SiC surface layer and a-Si photoconductive layer has already been in practical use.

However, with the electrophotographic photosensitive member having a-SiC surface layer, when incorporated in an image forming apparatus and undergoing printing processes, defective images with image deletion are likely to be caused. Such problems are likely to be caused especially under environment of high humidity.

Such image deletion is considered to be caused by water/moisture absorption at the surface layer due to corona discharge in printing. In corona discharge, discharge products such as nitrate ion and ammonium ion are generated and absorbed at the surface layer. These discharge products absorb moisture in the air under environment of high humidity, and thus the water absorption at the surface layer is increased. Further, Si atoms existing at the surface of the surface layer are oxidized in corona discharge, which increases hydrophilic property at the surface and thus increases moisture absorption at the surface layer. When water/moisture absorption at the surface layer is increased, electrical resistance at the surface layer is reduced, and electric charge of electrostatic latent image formed on the surface layer is caused to move. Thus, pattern of the electrostatic latent image is not maintained, which results in image deletion.

For preventing the image deletion, various methods have been suggested. An example of such methods is to heat the photosensitive member using a heater, so that moisture absorbed at the surface layer is removed. However, in this method, the heater complicates the structure and thus increases the product cost, and further, cost for driving the heater is also required.

Another example of methods for preventing the image deletion is to grind the surface of the photosensitive member using a grinding material such as barium carbonate, so that surface roughness of the photosensitive member is set within a predetermined range (see Patent Document 1, for example). However, in this method, though the heater may be omitted, grinding process of the surface layer deteriorates the workability, thereby increasing the product cost.

Still another example of methods for preventing the image deletion is to set the atom concentration of carbon and silicon as well as the dynamic indentation hardness of the surface layer within a predetermined range (see Patent Document 2, for example). In this method, the atom concentration of carbon and silicon in the surface layer is defined by a composition formula (a-Si₁₋ₓCₓ:H) of the surface layer, with value X (carbon content) of not less than 0.95 and less than 1.00. The dynamic indentation hardness of the surface layer is set to be smaller as proceeding from the boundary surface between the surface layer and the photoconductive layer toward the free surface, so that the surface is properly ground at each printing process by e.g. cleaning member provided in the printer. According to this technique, discharge products entered into concave portions on the surface, formed with fine projections in the beginning, are removed by flattening the projections in use of the photosensitive member. Further, since the hardness of the surface layer is increased as the surface is ground in use, abraded volume due to grinding is reduced. Thus, the surface is prevented from damage, so that enhanced electrophotographic property is maintained for a long period.

Patent Document 1: JP-B-7-89231

Patent Document 2: JP-B-3279926

### DISCLOSURE OF THE INVENTION

However, in the electrophotographic photosensitive member having a surface layer which is designed to be ground, scratches, streaks, and variations in grinding may be caused in use, which results in image degradation. Further, for uniformly grinding the a-SiC surface layer with a high hardness using an abrasive device, the product cost is significantly increased.

Recent years, image forming apparatuses are provided with higher image resolution and higher processing speed at lower cost, and accordingly, demand for higher image quality, higher durability and lower price has been increased. Therefore, the electrophotographic photosensitive member having a-SiC layer with high hardness, which is produced at low cost, has been required to resolve the problem of image deletion.

An object of the present invention is to provide a low-cost electrophotographic photosensitive member with long life and long-term reliability, in which grinding of surface layer is not required, and image deletion under environment of high humidity is prevented without using a heater, and to provide an image forming apparatus provided with such an electrophotographic photosensitive member.

A first aspect of the present invention provides an electrophotographic photosensitive member comprising a conductive body, a photoconductive layer formed on the conductive body using amorphous silicon, and a surface layer formed on the photoconductive layer using amorphous silicon. The photoconductive layer has a mean roughness Ra of not more than 10 nm per 10 μm square.

The surface layer has a mean roughness Ra of not more than 10 nm per 10 μm square.

A second aspect of the present invention provides an electrophotographic photosensitive member comprising a conductive body, a photoconductive layer formed on the conductive body using amorphous silicon, and a surface layer formed on the photoconductive layer using amorphous silicon. The photoconductive layer has a ten-point mean roughness Rz of not more than 50 nm per measurement length of 100 μm.

The surface layer has a ten-point mean roughness Rz of not more than 50 nm per measurement length of 100 μm.

A third aspect of the present invention provides an electrophotographic photosensitive member comprising a conductive body, a photoconductive layer formed on the conductive body using amorphous silicon, and a surface layer formed on the photoconductive layer using amorphous silicon. The photoconductive layer has a centerline mean roughness Ra(a) of not more than 10 nm, Ra(a) calculated from a boundary curve a between the photoconductive layer and the surface layer per measurement length of 2.5 μm, as seen in a cross-section photograph taken by a field emission scanning electron microscope.

The surface layer has a centerline mean roughness Ra(b) of not more than 10 nm, Ra(b) calculated from a boundary curve b of the surface layer per measurement length of 2.5 μm, as seen in a cross-section photograph taken by a field emission scanning electron microscope.

A fourth aspect of the present invention provides an electrophotographic photosensitive member comprising a conductive body, a photoconductive layer formed on the conductive body using amorphous silicon, and a surface layer formed on the photoconductive layer using amorphous silicon. The photoconductive layer has a ten-point mean roughness Rz(a) of not more than 50 nm, Rz(a) calculated from a boundary curve a between the photoconductive layer and the surface layer per measurement length of 2.5 μm, as seen in a cross-section photograph taken by a field emission scanning electron microscope.

The surface layer has a ten-point mean roughness Rz(b) of not more than 50 nm, Rz(b) calculated from a boundary curve b of the surface layer per measurement length of 2.5 μm, as seen in a cross-section photograph taken by a field emission scanning electron microscope.

A fifth aspect of the present invention provides an electrophotographic photosensitive member comprising a conductive body, a photoconductive layer formed on the conductive body using amorphous silicon, and a surface layer formed on the photoconductive layer using amorphous silicon. The surface layer has a mean roughness Ra of not more than 10 nm per 10 μm square, without undergoing grinding process.

A sixth aspect of the present invention provides an electrophotographic photosensitive member comprising a conductive body, a photoconductive layer formed on the conductive body using amorphous silicon, and a surface layer formed on the photoconductive layer using amorphous silicon. The surface layer has a ten-point mean roughness Rz of not more than 50 nm per measurement length of 100 μm, without undergoing grinding process.

A seventh aspect of the present invention provides an electrophotographic photosensitive member comprising a conductive body, a photoconductive layer formed on the conductive body using amorphous silicon, and a surface layer formed on the photoconductive layer using amorphous silicon. The surface layer, without undergoing grinding process, has a centerline mean roughness Ra(b) of not more than 10 nm, Ra(b) calculated from a boundary curve b of the surface layer per measurement length of 2.5 μm, as seen in a cross-section photograph taken by a field emission scanning electron microscope.

A eighth aspect of the present invention provides an electrophotographic photosensitive member comprising a conductive body, a photoconductive layer formed on the conductive body using amorphous silicon, and a surface layer formed on the photoconductive layer using amorphous silicon. The surface layer, without undergoing grinding process, has a ten-point mean roughness Rz(b) of not more than 50 nm, Rz(b) calculated from a boundary curve b of the surface layer per measurement length of 2.5 μm, as seen in a cross-section photograph taken by a field emission scanning electron microscope.

A ninth aspect of the present invention provides an image forming apparatus comprising the electrophotographic photosensitive member according to any one of first to eighth aspects of the present invention.

According to the present invention, since the surface roughness at the photoconductive layer before forming the surface layer is set to not more than a predetermined value, the surface roughness at the surface layer formed on the photoconductive layer is easily set to not more than a predetermined value, without performing grinding process.

By setting the surface roughness at the surface layer to not more than a predetermined value, discharge products due to corona discharge in use are prevented from being adsorbed to the surface layer, and discharge products adsorbed to the surface layer are easily removed by cleaning. As a result, even the surface layer has a high hardness and thus is difficult to be ground, the electrophotographic photosensitive member is made to have high durability, in which image deletion is unlikely to be formed even in environment of high temperature and humidity, and images of high quality are obtained for a long period.

### BRIEF DESCRIPTION OF THE DRAWINGS

FIG. 1 is a sectional view illustrating an example of an image forming apparatus according to the present invention.

FIG. 2 is a schematic view illustrating an example of an electrophotographic photosensitive member according to the present invention.

FIG. 3 is a photograph of an Al cylindrical body in Example 3, taken by AFM.

FIG. 4 is a photograph of a photosensitive member A (according to the present invention) in Example 3, taken by AFM.

FIG. 5 is a photograph of a photosensitive member D (according to the present invention) in Example 3, taken by AFM.

FIG. 6 is a photograph of a photosensitive member E (as a comparative sample) in Example 3, taken by AFM.

FIG. 7 is a photograph of a photosensitive member F (as a comparative sample) in Example 3, taken by AFM.

FIG. 8 is a profile of surface roughness of the photosensitive member A (according to the present invention) in Example 4.

FIG. 9 is a profile of surface roughness of the photosensitive member D (according to the present invention) in Example 4.

FIG. 10 is a profile of surface roughness of the photosensitive member E (as a comparative sample) in Example 4.

FIG. 11 is a profile of surface roughness of the photosensitive member F (as a comparative sample) in Example 4.

FIG. 12 is a photograph of cross-section of the photosensitive member A (according to the present invention) in Example 5, taken by FE-SEM.

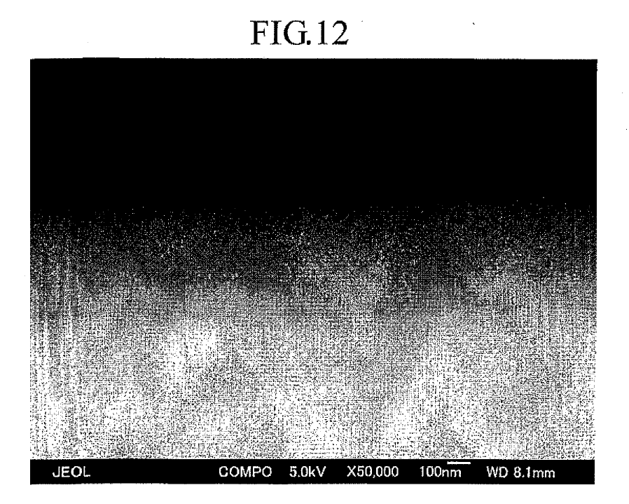

FIG. 13 is a photograph of cross-section of the photosensitive member E (as a comparative sample) in Example 5, taken by FE-SEM.

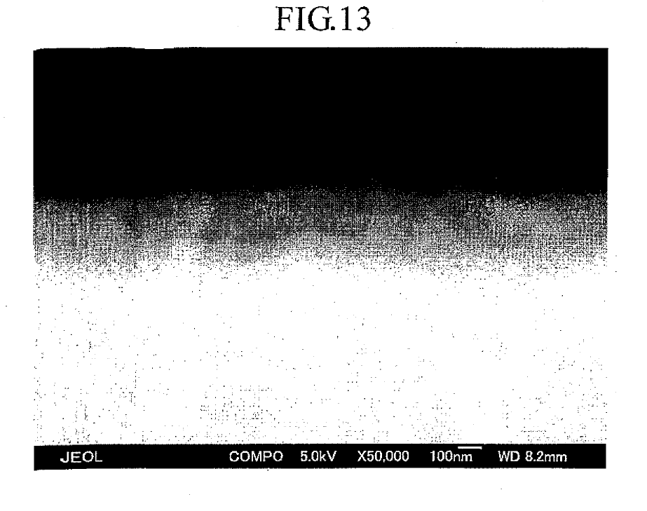

### LEGENDS

1 Image Forming Apparatus
2 Electrophotographic Photosensitive Member
20 Cylindrical body (Conductive Body)
22 Photoconductive Layer
23 Surface Layer

### BEST MODE FOR CARRYING OUT THE INVENTION

An image forming apparatus and an electrophotographic photosensitive member according to the present invention are specifically described below with reference to the accompanying drawings.

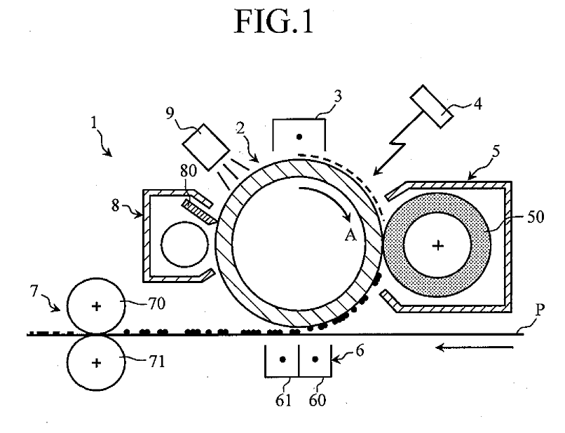

An image forming apparatus 1 shown in FIG. 1 includes an electrophotographic photosensitive member 2, an electrification mechanism 3, an exposure mechanism 4, a development mechanism 5, a transfer mechanism 6, a fixing mechanism 7, a cleaning mechanism 8, and a discharging mechanism 9.

The electrophotographic photosensitive member 2 forms an electrostatic latent image or a toner image according to an image signal, and can be rotated in the direction of an arrow A in the figure. The electrophotographic photosensitive member 2 will be specifically described below.

The electrification mechanism 3 uniformly charges the surface of the electrophotographic photosensitive member 2, positively and negatively according to the type of the photoconductive layer of the electrophotographic photosensitive member 2. The electrophotographic photosensitive member 2 is charged at electrical potential of not less than 200V and not more than 1000V.

The exposure mechanism 4 serves to form an electrostatic latent image on the electrophotographic photosensitive member 2, and is capable of emitting laser light. The exposure mechanism 4 forms an electrostatic latent image by irradiating the surface of the electrophotographic photosensitive member 2 with laser light according to an image signal, and lowering the electrical potential at the irradiated portion.

The development mechanism 5 forms a toner image by developing the electrostatic latent image formed on the electrophotographic photosensitive member 2. The development mechanism 5 holds developer and is provided with a developing sleeve 50.

The developer serves to develop a toner image formed on the surface of the electrophotographic photosensitive member 2, and is frictionally charged at the development mechanism 5. The developer may be a binary developer of magnetic carrier and insulating toner, or a one-component developer of magnetic toner.

The developing sleeve 50 serves to transfer the developer to a developing area between the electrophotographic photosensitive member 2 and the developing sleeve 50.

In the development mechanism 5, the toner frictionally charged by the developing sleeve 50 is transferred in a form of magnetic brush with bristles each having a predetermined length. In the developing area between the electrophotographic photosensitive member 2 and the developing sleeve 50, the electrostatic latent image is developed using the toner, thereby forming a toner image. When the toner image is formed by regular developing, the toner image is charged in the reverse polarity of the polarity of the surface of the electrophotographic photosensitive member 2. On the other hand, when the toner image is formed by reverse developing, the toner image is charged in the same polarity as the polarity of the surface of the electrophotographic photosensitive member 2.

The transfer mechanism 6 transfers the toner image of the electrophotographic photosensitive member 2 on a recording medium P supplied to a transfer area between the electrophotographic photosensitive member 2 and the transfer mechanism 6. The transfer mechanism includes a transfer charger 60 and a separation charger 61. In the transfer mechanism 6, the rear side (non-recording surface) of the recording medium P is charged in the reverse polarity of the toner image by the transfer charger 60, and by the electrostatic attraction between this electrification charge and the toner image, the toner image is transferred on the recording medium P. Further, in the transfer mechanism 6, simultaneously with the transfer of the toner image, the rear side of the recording medium P is charged in alternating polarity by the separation charger 61, so that the recording medium P is quickly separated from the surface of the electrophotographic photosensitive member 2.

As the transfer mechanism 6, a transfer roller driven with the rotation of the electrophotographic photosensitive member 2, and being spaced from the electrophotographic photosensitive member 2 by a minute gap (generally, not more than 0.5 mm) may be used. Such a transfer roller applies a transfer voltage to the recording medium P, using e.g. direct-current power source, for attracting the toner image of the electrophotographic photosensitive member 2 onto the recording medium. When using such a transfer roller, a separation member such as the separation charger 61 is omitted.

The fixing mechanism 7 serves to fix a toner image transferred onto the recording medium P, and includes a pair of fixing rollers 70, 71. In the fixing mechanism 7, the recording medium P passes through between the fixing rollers 70, 71, so that the toner image is fixed on the recording medium P by heat or pressure.

The cleaning mechanism 8 serves to remove the toner remaining on the surface of the electrophotographic photosensitive member 2, and includes a cleaning blade 80. In the cleaning mechanism 8, the toner remaining on the surface of the electrophotographic photosensitive member 2 is scraped off by the cleaning blade 80 and is collected. The toner collected in the cleaning mechanism 8 is recycled at the development mechanism 5, if necessary.

The discharging mechanism 9 serves to remove surface charge on the electrophotographic photosensitive member 2. The discharging mechanism 9 removes the surface charge of the electrophotographic photosensitive member 2 by e.g. light irradiation.

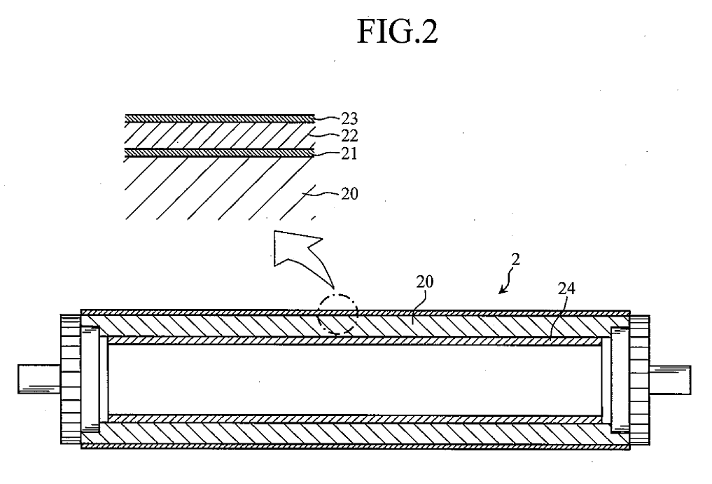

As shown in FIG. 2, the electrophotographic photosensitive member 2 includes a cylindrical body 20 having an anti-charge injection layer 21, a photoconductive layer 22, and a surface layer 23 formed on its circumferential outer surface.

The cylindrical body 20 forms the skeleton of the electrophotographic photosensitive member 2 and is conductive at least at the surface. The cylindrical body 20 may be made of a conductive material as a whole, or may be made by forming a conductive film on a surface of a cylindrical body made of an insulating material. In order to form the anti-charge injection layer 21, the photoconductive layer 22, and the surface layer 23 as smooth film, the surface of the cylindrical body 20 has an adequate smoothness. Specifically, the cylindrical body 20 has a mean surface roughness of not less than 0.5 nm and not more than 10 nm, per 10 μm square.

The conductive material for forming the cylindrical body 20 may include metal such as aluminum (Al), stainless (SUS), zinc (Zn), copper (Cu), iron (Fe), titan (Ti), nickel (Ni), chrome (Cr), tantalum (Ta), tin (Sn), gold (Au), and silver (Ag), and an alloy of these metals, for example.

The insulating material for forming the cylindrical body 20 may include resin, glass, and ceramic. The material for forming the conductive film may include a transparent conductive material such as ITO and SnO2, other than the above-described metals.

Preferably, the cylindrical body 20 is formed of Al alloy material as a whole. In this way, the electrophotographic photosensitive member 2 having a light weight can be made at a low cost, and further, the adhesion of the cylindrical body to the anti-charge injection layer 21 and the photoconductive layer 22, is reliably enhanced when forming the layers by a-Si material.

The cylindrical body 20 accommodates a flat heater 24. The flat heater 24 serves to evaporate moisture on the surface of the surface layer 23, and is adhered to the inner surface of the cylindrical body 20. The flat heater 24 includes an insulating base made of e.g. silicon, in which a meandering striate heating element is embedded. When moisture on the surface of the surface layer 23 is evaporated by the flat heater 24, to prevent decrease in electrical resistance at the surface layer 23 due to moisture, and thus image deletion is more reliably prevented.

As will be described below, surface roughness is set to be relatively small at the surface layer 23 of the electrophotographic photosensitive member 2, so that moisture is hardly attached to the surface layer 23. Thus, the heater 24 is not essential but optional in the electrophotographic photosensitive member 2.

The anti-charge injection layer 21 serves to block injection of carriers (electrons) from the cylindrical body 20, and is made of a-Si material. The anti-charge injection layer 21 is smooth film with a thickness of about not less than 2 μm and not more than 10 μm, and is formed on the surface of the cylindrical body 20 which has an adequate smoothness. Thus, even with the anti-charge injection layer 21 existing between the cylindrical body 20 and the photoconductive layer 22, the photoconductive layer 22 and the surface layer 23 formed thereon can maintain adequate smoothness.

In the photoconductive layer 22, electrons are excited by a laser irradiation from the exposure mechanism 4 (see FIG. 1), and a carrier of free electrons or electron holes is generated. The photoconductive layer is formed of a-Si material.

The film thickness of the photoconductive layer 22 is set according to the photoconductive material and desired electrophotographic property. When using a-Si material, the thickness is normally set to not less than 5 μm and not more than 100 μm, and preferably, not less than 10 μm and not more than 80 μm. It is preferable that variation in film thickness of the photoconductive layer 22 in the axial direction is set within ±3% relative to the thickness at the intermediate portion. If the variation in film thickness of the photoconductive layer 22 is relatively large, differences in the withstand pressure (leading to leakage) and the outer diameter of the electrophotographic photosensitive member may occur so that problem in image may be caused in the axial direction.

The surface of the photoconductive layer 22 is formed into a smooth surface to meet any one of the following conditions.

(1) The mean roughness Ra is not more than 10 nm (10×10⁻³ μm) per 10 μm square.

(2) The ten-point mean roughness Rz is not more than 50 nm (50×10⁻³ μm) per measurement length of 100 μm.

(3) The centerline mean roughness Ra(a) is not more than 10 nm (10×10⁻³ μm) per measurement length of 2.5 μm, calculated from a boundary curve a between the photoconductive layer 22 and the surface layer 23, as seen in a cross-section photograph taken by a field emission scanning electron microscope.

(4) The ten-point mean roughness Rz(a) is not more than 50 nm (50×10⁻³ μm) per measurement length of 2.5 μm, calculated from a boundary curve a between the photoconductive layer 22 and the surface layer 23, as seen in a cross-section photograph taken by a field emission scanning electron microscope.

On the photoconductive layer 22 with such a smooth surface, the surface layer 23 is easily formed to have a surface roughness similar to that of the photoconductive layer 22. Thus, grinding process of the surface layer 23 for preventing image deletion due to moisture attached to the surface layer 3 is almost or completely unnecessary. In this way, it is possible to control increase in production cost due to grinding process of the surface layer 23. Further, the heater 24 for evaporating moisture at the surface layer 23 is also dispensable. In this case, the production cost for the heater 24 as well as the running cost for driving the heater 24 can be saved.

The surface roughness of the photoconductive layer 22 is defined and measured as described below.

The mean roughness Ra per 10 μm square and the ten-point mean roughness Rz per measurement length of 100 μm are measured by an atomic force microscope (hereinafter referred to as “AFM”), “NanoScope” (manufactured by Digital Instruments in February, 1995). For measuring fine projections, formed by nuclear growth in film forming of the photoconductive layer 22 and the surface layer 23, with high accuracy and repeatability, it is preferable to measure within an area of 10 μm square, while correcting an error due to slope of curvature of a sample.

Specifically, by using PlaneFit Auto command in Offline Modify menu of the “NanoScope” manufactured by Digital Instruments, the curvature and the slope of AFM image of a sample is corrected. Since the electrophotographic photosensitive member is commonly cylindrical, the above method is preferable. In this way, the slope of a sample is properly corrected without causing distortion in data.

With a plane image of 10 μm square obtained in the above-described way, the mean roughness Ra is measured by using Section Roughness command of Analyze menu.

Here, the mean roughness Ra is defined by the following Formula 1, which is described in pages 12-54 of “Command Reference Manual for Scanning Probe Microscope NanoScope Ver. 4.10” provided by Digital Instruments, or Roughness Analysis section of an operation manual “Offline Function of NanoScope III Ver. 3.20” provided by TOYO Corporation.

Ra=(1/LxLy)∫₀^{Lx}∫₀^{Ly}|f(x,y)|dxdy [Formula 1]

In measuring the ten-point mean roughness Rz per measurement length of 100 μm, a plane image of 100 μm square is obtained in the same way as the measurement of the above mean roughness Ra. On the plane image, any linear portion is selected using Section command of Analyze menu, and an average of values at ten points of a roughness curve on the selected linear portion is calculated. Generally, fine projections formed by nuclear growth in forming a-Si film have dimensions ranging from not less than 1 μm and not more than 2 μm, to a few micrometers. Thus, for calculating the ten-point mean roughness, the number of peaks is not enough within an area of 10 μm square. Therefore, it is preferable that the measurement is performed at a length of not less than 50 μm, and thus performed within 100 μm square in the present invention.

The mean roughness Rz is defined by the following Formula 2, utilizing values obtained by ten-point measurement method.

Rz=(average of values at top 5 points)−(average of values at low 5 points) [Formula 2]

The present inventors performed measurement using AMF, at various scanning sizes. Here, scanning size is a length of one side of a rectangular area which is to be scanned. When the scanning size is 10 μm, 10 μm square, that is 100 μm², area is scanned.

When the scanning size or the measured area is enlarged, measurement value is stabilized, though may be affected by irregularities on a sample body, such as undulation, processed shape, projections and pin holes. On the other hand, when the scanning size is very small, variations are caused in measurement. Thus, in the present invention, 10 μm square area is utilized for stably measuring fine projections formed on the surface due to nuclear growth in forming a-Si film. However, the technical art of the present invention is not limited to the measurement within 10 μm square (scanning size of 10 μm). The measurement length in the present invention is not limited, either.

It is not necessary to set the normal cutoff defined by e.g. JIS (to which setting of Lowpass Filter and Highpass Filter in Measurement menu corresponds) since the measurement range is very short (narrow).

Further, the following steps are performed in the present invention, to obtain the centerline mean roughness and the ten-point mean roughness per measurement length of 2.5 μm, calculated from a boundary curve a between the photoconductive layer and the surface layer as well as from a curve b of the surface layer, as seen in a cross-section photograph taken by a field emission scanning electron microscope (hereinafter referred to as “FE-SEM”).

First, a sample is cut out from the electrophotographic photosensitive member according to the present invention, and a photograph of its cross-section is taken by FE-SEM “JSM7401F” manufactured by JEOL Ltd. The cross-section photograph is taken at not less than 10,000-fold magnification for observing the projections, preferably at about 50,000-fold magnification.

In the cross-section photograph taken by the electron microscope, the photoconductive layer 22 made of a-Si and the surface layer made of a-SiC appear to have different colors (densities) due to the difference in composition. Thus, in the photograph, the boundary surface between the photoconductive layer 22 and the surface layer 23 is clearly shown by the difference in colors (densities). Then the mean roughnesses Ra, Rz are calculated from a curve of the boundary surface and a curve of the surface of the photosensitive member. Specifically, using a cross-section photograph taken at 50,000-fold magnification, the centerline mean roughness Ra and the ten-point mean roughness are calculated, per an area with maximum length of 2.5 μm. The mean roughnesses Ra and Rz are defined by the following Formula 3 and Formula 4.

Ra=(1/Lx)∫0Lx|f(x)|dx [Formula 3]

Rz=(average of values at top 5 points)−(average of values at low 5 points) [Formula 4]

The present inventors compared the values of Ra and Rz, obtained from the cross-section photograph taken by the electron microscope, with values measured by the AFM at a photosensitive member formed only with the photoconductive layer 22 and without the surface layer 23, and the values were generally the same. Thus, with the above-described steps, even in the electrophotographic photosensitive member 1 on which the surface layer 23 is already formed, the accurate surface roughness of the photoconductive layer 22 before forming the surface layer 23 can be obtained.

In some cases, the cylindrical body 20 for the electrophotographic photosensitive member 1 according to the present invention has a trace of processing by e.g. cutting tool in the circumferential direction at intervals of processing pitch, during surface processing such as cutting and grinding of the circumferential outer surface. The above-described measurement of roughness is to be performed at an inclined portion between a peak and a trough of projections, for example, circumventing an area with the irregularities due to the trace of processing on the cylindrical body 20 (where a distance between adjacent peaks of projections is not less than 10 μm and not more than 500 μm, and a difference in height of the peaks and the troughs is not less than 0.03 μm for example). Especially in measurement of ten-point mean roughness per measurement length of 100 μm, when the measurement is performed along, the longitudinal direction (axial direction) of the cylindrical body 20, the irregularities are likely to exist in the measured area. Thus, it is preferable to measure along the circumference to circumvent the irregularities.

As described above, the anti-charge injection layer 21 and the photoconductive layer 22 are made of a-Si material such as a-Si, and preferably made of a-Si alloy material containing a-Si and carbon (C), nitrogen (N), or oxygen (O). In this way, enhanced electrophotographic property such as high photoconductivity, high-speed responsiveness, stable repeatability, high heat resistance, or high endurance is steadily obtained, and additionally, conformity with the surface layer 23 made of a-Si material is enhanced.

As the a-Si alloy material containing a-Si and carbon (C), nitrogen (N), or oxygen (O), a-SiC, a-SiN, a-SiO, a-SiGe, a-SiCN, a-SiNO, a-SiCO or a-SiCNO may be used. The anti-charge injection layer 21 and the photoconductive layer 22 containing the above a-Si material are formed by glow discharge decomposition method, various sputtering methods, various vapor deposition methods, ECR method, photo-induced CVD method, catalyst CVD method, and reactive vapor deposition method, for example. In the film forming, hydrogen (H) or a halogen element (F, Cl) may be contained in the film by not less than one atom % and not more than 40 atom % for dangling-bond termination. Further, in forming the anti-charge injection layer 21 and the photoconductive layer 22, for obtaining a desired property such as electrical property including e.g. dark conductivity and photoconductivity as well as optical bandgap, thirteenth group element of the periodic system (hereinafter referring to as “thirteenth group element”) or fifteenth group element of the periodic system (hereinafter referring to as “fifteenth group element”), or an adjusted amount of element such as carbon (C), nitrogen (N), or oxygen (O) may be contained.

As the thirteenth group element and the fifteenth group element, in view of high covalence and sensitive change of semiconductor property, as well as of high luminous sensitivity, it is desired to use boron (B) and phosphorus (P). When the anti-charge injection layer 21 contains the thirteenth group element and the fifteenth group element in combination with elements such as carbon (C) and oxygen (O), preferably, the thirteenth group element may be contained by not less than 0.1 ppm and not more than 20000 ppm, while the fifteenth group element may be contained by not less than 0.1 ppm and not more than 10000 ppm. When the photoconductive layer 22 contains the thirteenth group element and the fifteenth group element in combination with elements such as carbon (C) and oxygen (O), or when the anti-charge injection layer 21 and the photoconductive layer 22 contain no elements such as carbon (C) and oxygen (O), preferably, the thirteenth group element may be contained by not less than 0.1 ppm and not more than 200 ppm, while the fifteenth group element may be contained by not less than 0.01 ppm and not more than 100 ppm. These elements may be contained in a manner such that concentration gradient is generated in the thickness direction of the layers, if the average content of the elements in the layers is within the above-described range.

The anti-charge injection layer 21 may contain boron (B), nitrogen (N), or oxygen (O) added as a dopant, and the thirteenth group element and the fifteenth group element in an amount larger than those contained in the photoconductive layer 22 so as to determine the conductivity type. Further, a large amount of nitrogen (N) or oxygen (O) may be also contained so as to have high resistivity. It is required to obtain adequate ion sputtering effect to have smooth anti-charge injection layer 21.

In forming the photoconductive layer 22 using a-Si material, microcrystal silicon (μc-Si) may be contained, which enhances dark conductivity and photoconductivity, and thus advantageously increases design freedom of the photoconductive layer 21A. Such μc-Si can be formed by utilizing a method similar to the above-described method, and by changing the film forming condition. For example, when utilizing glow discharge decomposition method, the layer can be formed by setting temperature and high-frequency electricity at the cylindrical body 20 to be relatively high, and by increasing flow amount of hydrogen as diluent gas. Further, when the photoconductive layer 22 contains μc-Si, the above-described elements (the thirteen group element, the fifteen group element, carbon (C) and oxygen (O)) may be added.

Next, film forming method of the photoconductive layer 23 having the above-described surface roughness is described in further detail. In the following description, the photoconductive layer 23 is formed using a-Si.

Before describing the film forming method of the photoconductive layer 23, generation of fine projections due to nuclear growth, which is the determinant of the surface roughness of the photoconductive layer 23, is first described.

In a-Si film growth in common plasma CVD method, in early phase of growth, the growing nuclear is attached to the cylindrical body 20, and forms “islands”.

The “islands” attached to the cylindrical body 20 grow gradually, and later overlap with each other to form a film. Since such process is repeated in film forming, the surface of a-Si film with a thickness of about 20 μm has projections, each having a dimension of not less than 0-5 μm and not more than a few micrometers, which are traces of the “islands” in the early phase of growth, and further, smaller projections are observed thereon. The dimension of the projections becomes larger as the film thickness becomes larger.

When forming a-Si film on the cylindrical body 20 which has a surface roughness of only a few nanometers, the a-Si photoconductive layer 22 may have a large surface roughness of not less than 10 nm, which can be considered as influence of the above-described nuclear growth, not of the surface roughness of the cylindrical body 20.

As a result of keen study of the present inventors, it was discovered that, an effective way to reduce the surface roughness of the a-Si photoconductive layer 22 is to reduce the size of projections generated by nuclear growth, utilizing ion bombardment in plasma.

Generally, in plasma CVD method, a material gas introduced in a CVD device is decomposed to generate deposited species, by applying electricity at RF band of not less than 13.56 MHz, VHF band of not less than 50 MHz and not more than 150 MHz, or microwave band of larger frequency. Positive ion species (cation) such as SiHₓ⁺ and H₂⁺, and negative ion species (anion) such as SiH₃⁻ exist in plasma of SiH₄ gas (silane gas) as a material gas, in addition to SiH₃ radical which is a main component of deposited species.

In a plasma CVD device, a discharge electrode and the cylindrical body 20 are positioned so that a proper discharge gap is provided therebetween, and the above-described SiH₃ radical and positive/negative ion exist therebetween.

When high-frequency electricity is applied at the RF band of not less than 13.56 MHz, ion species generated in the air are accelerated by the electric field, and drawn in a direction corresponding to the positive or negative pole. However, since the electric field is continually reversed due to high-frequency AC, the ion species repeat recombination in the air before arriving at the cylindrical body 10 or the discharging electrode, and are discharged as gas or a silicon compound such as polysilicon powder. The present inventors applied electricity having electric field of positive or negative polarity, so that the cylindrical body 20 is actively bumped by ion, and that plasma is generated to decompose the material gas.

In the present invention, specifically, when applying pulse rectangular wave voltage to the cylindrical body 20 to have negative polarity, cations are accelerated to bump into the cylindrical body 20, and the impact of the bump can be used for sputtering fine projections at the surface of the body while forming a-Si film. In this way, a-Si film having a surface with very little projections can be obtained. The inventor named this phenomenon as “ion sputtering effect”.

In such plasma CVD method, in order to efficiently obtain the ion sputtering effect, it is necessary to apply electric power in a manner that continual reversal of polarity is prevented, for which triangular wave, DC power, and DC voltage is usable in addition to the above pulse rectangular wave. Further, AC power can be also used if the whole voltage is adjusted to have either of positive and negative polarity. The polarity of the applied voltage can be freely changed in consideration of film forming rate which depends on ion species density and polarity of deposited species, corresponding to the type of material gas.

Further, in order to efficiently obtain the ion sputtering effect utilizing pulse voltage, the pulse rectangular wave voltage is set to have potential difference of not less than −3000V to not more than −50V, frequency of not more than 300 kHz, and duty ratio on:off of 20-90%:80-10%, for example.

In the a-Si photoconductive layer 22 formed by utilizing the ion sputtering effect, even when the thickness is not less than 10 μm, the fine projections on the surface are so small that smoothness is not deteriorated. Thus, when a-SiC surface layer 23 is laminated on the photoconductive layer 22 to have a thickness of about 1 μm, the surface layer 23 has a smooth surface corresponding to the surface of the photoconductive layer 22. Therefore, there is no need to perform e.g. grinding process for enhancing the smoothness of the surface layer 23 after film forming of the surface layer 23.

The surface protection layer 23 serves to enhance quality and stability of electrophotographic property, such as potential characteristic (i.e. charging characteristic, optical sensitivity and residual potential) and image characteristic (i.e. image density, image resolution, image contrast and image tone), as well as durability (against friction, wear, environment and chemical) in the electrophotographic photosensitive member 2. The surface layer 23 has a wide optical band gap so that light emitted to the electrophotographic photosensitive member 2 of the image forming apparatus 1 (see FIG. 1) is prevented from unduly absorbed by the surface layer 23 before arriving at the photoconductive layer 22, and also has a resistance (generally not less than 10¹¹ Ω·cm) enabling to hold an electrostatic latent image in image forming.

The surface layer 23 is formed of a-Sic or a-SiN to have a high hardness for enduring wear due to rubbing in the image forming apparatus 1 (see FIG. 1), and has a film thickness of not less than 0.2 μm and not more than 1.5 μm, for example, preferably not less than 0.5 μm and not more than 1.0 μm.

The surface of the surface layer 23 is formed into a smooth surface to meet any one of the following conditions. The surface roughness of the surface layer 23 is defined and measured similarly to that of the photoconductive layer 22.

(1) The mean roughness Ra is not more than 10 nm (10×10⁻³ μm) per 10 μm square.

(2) The ten-point mean roughness Rz is not more than 50 nm (50×10⁻³ μm) per measurement length of 100 μm.

(3) The centerline mean roughness Ra(b) is not more than 10 nm (10×10⁻³ μm) per measurement length of 2.5 μm, calculated from a surface curve b of the surface layer 3, as seen in a cross-section photograph taken by a field emission scanning electron microscope.

(4) The ten-point mean roughness Rz(b) is not more than 50 nm (50×10⁻³ μm) per measurement length of 2.5 μm, calculated from a surface curve b of the surface layer 3, as seen in a cross-section photograph taken by a field emission scanning electron microscope.

The surface layer 23 having such surface roughness prevents adsorption of discharge products on the surface layer 23 due to corona discharge of the discharge mechanism 3 (see FIG. 1) during printing, and discharge products adsorbed to the surface layer 23 are easily removed by the cleaning mechanism 8. Therefore, even the surface layer 23 has high hardness and thus is difficult to be ground, the electrophotographic photosensitive member 2 is made to have high durability, in which image deletion is unlikely to be formed even in environment of high temperature and humidity, and images of high quality are obtained for a long period.

The hardness of the surface layer 23 is controlled by relative proportions of C and Si, gas dilution rate of H₂ gas in film forming, and pulse voltage, to have dynamic indentation hardness ranging within about not less than 30 kgf/mm² and not more than 800 kgf/mm². The above-described JP-B-3279926 also discloses that the hardness of the surface layer 23 is an important parameter for determining the functions of the electrophotographic photosensitive member 2, such as cleaning performance, durability, and environment resistance (anti-image deletion), and that image deletion is likely to be caused in a conventional electrophotographic photosensitive member with very high surface hardness. Thus, in the electrophotographic photosensitive member according to JP-B-3279926, the dynamic indentation hardness becomes smaller as proceeding from the boundary surface between the surface layer and the photoconductive layer 23 toward the free surface. Further, the dynamic indentation hardness at the free surface is set to not less than 45 kgf/mm² and not more than 220 kgf/mm², so that the surface layer is suitably abraded to prevent image deletion.

On the other hand, in the present electrophotographic photosensitive member 2, since the surface is formed to have relatively small fine projections and be smooth from the beginning, there is no need to reduce the dynamic indentation hardness at the free surface such that the surface layer is likely to be abraded. Even the hardness is more than 300 kgf/mm² at the free surface, the image deletion is prevented reliably.

Such surface layer 23 is formed by basically the same method of the anti-charge injection layer 21 and the photoconductive layer 22, except that source of C or N is contained in material gas.

Examples of the source of C for forming the surface layer 23 include CH₄, C₂H₂, C₃H₈, CO, and CO₂, for example, while as the source of N, NO may be used. The a-SiC surface layer 23 may be formed by decomposing a material gas containing Si-containing gas such as SiH₄ (silane gas) and C-containing gas such as CH₄ (methane gas) by e.g. glow discharge, and then depositing the decomposition product on the surface of photoconductive layer 22.

For manufacturing reason such that film forming rate is generally lowered as C content gets larger, in the surface layer 23, Si content may be larger at the side of the photoconductive layer 22 (inner side) while smaller at the side of the surface layer 22 (outer side) Specifically, the surface layer 23 may have a double-layered structure by forming a first SiC layer containing a relatively high rate of Si, in which value X (carbon content) in amorphous hydrogenated silicon carbide (a-Si₁₋ₓCₓ:H) is more than 0 and less than 0.8, and then forming a second SiC layer containing a high rate of C, in which the value X (carbon content) is about not less than 0.95 and less than 1.0. The relative proportions of Si and C is controlled by changing the mixture ratio of Si-containing gas and C-containing gas.

The thickness of the first SiC layer is determined in view of durability, residual potential, and film strength, and is set to normally not less than 0.1 μm and not more than 2.0 μm, preferably not less than 0.2 μm and not more than 1.0 μm, and most preferably not less than 0.3 μm and not more than 0.8 μm. The thickness of the second SiC layer is determined in view of durability, residual potential, film strength, and endurance (anti-wear), and is set to normally not less than 0.1 μm and not more than 2.0 μm, preferably not less than 0.2 μm and not more than 1.0 μm, and most preferably not less than 0.05 μm and not more than 0.8 μm

When C-content is relatively high at the surface of the surface layer 23, Si-content is accordingly lowered, which prevents oxidation of Si existing at the surface of the surface layer 23, due to e.g. ozone generated by corona discharge in the image forming apparatus (see FIG. 1). This prevents increase in moisture absorption by the surface layer 23 due to oxidation of the surface layer 23, thereby preventing image deletion under environment of high temperature and humidity.

In film forming of the surface layer 23, similarly to that of the photoconductive layer 22, pulse rectangular wave voltage is applied in plasma CVD method. Here, similarly to film forming of the photoconductive layer 22, ion sputtering effect is obtained, and if the photoconductive layer 22 has a proper smoothness, smoothness of the surface layer 23 is also properly obtained.

However, if the ion sputtering effect is not adequately obtained in forming the photoconductive layer 22, since the thickness of the surface layer 23 is generally no more than a few micrometers, as described above, it is difficult to smoothing the fine projections formed on the photoconductive layer 22 only by ion sputtering effect obtained in forming the surface layer 23. The present inventors performed an experiment, in which the photoconductive layer 22 was formed by a conventional RF plasma CVD method at 13.56 MHz (so that fine projections were formed on the photoconductive layer), and then the surface layer 23 was formed of SiC to have a thickness of 1 μm by applying pulse rectangular wave voltage to obtain adequate ion sputtering effect. As a result, the photosensitive member manufactured in the experiment did not obtain a surface with a small surface roughness.

Therefore, in order to obtain the effect of the present invention, that is, to obtain, without grinding process, the electrophotographic photosensitive member 2 which includes the surface layer 23 with a smoothness higher than that of a conventional electrophotographic photosensitive member, it is required to form the photoconductive layer 22 to have a smooth surface with reduced fine projections.

The present invention is not limited to the above-described embodiments and may be variously changed. For example, the anti-charge injection layer may be omitted in the electrophotographic photosensitive member, and in place of or in addition to the anti-charge injection layer, a long-wavelength absorption layer may be provided. The long-wavelength absorption layer prevents light of exposure with long-wavelength from reflecting at the surface of the cylindrical body 20, and thus prevents fringe pattern in images. Further, a transition layer or a carrier excitation layer may be provided between the photoconductive layer 22 and the surface layer 23.

### Example 1

In the present example, the electrophotographic photosensitive member was manufactured as described below, and evaluation was performed with respect to surface roughness and composition of the surface layer, and dynamic indentation hardness at the boundary surface between the surface layer and the photoconductive layer. Evaluation was also performed with respect to wear volume and image deletion at the electrophotographic photosensitive member.

[Manufacture of Electrophotographic Photosensitive Member]

An electrophotographic photosensitive member for the present example was made by forming an anti-charge injection layer, a photoconductive layer, and a surface layer on the surface of a cylindrical body.

The cylindrical body was prepared by making a drawn tube of aluminum alloy with outer diameter of 30 mm, length of 340 mm and thickness of 1.5 mm, and then performing mirror finishing on the circumferential outer surface of the drawn tube before cleaning.

The cylindrical body was placed in the glow discharge decomposition device, and the anti-charge injection layer, the photoconductive layer, and the surface layer were formed under the film forming conditions shown in Table 1. Here, the element content is defined by a composition formula a-Si₁₋ₓCₓ:H. The surface layer was formed to have a double-layered structure including a first layer formed at the side of the photoconductive layer (inner side) with value X of not less than 0.5 and not more than 0.8, and a second layer formed at the side of the surface (outer side) with value X of not less than 0.95 and less than 1.00. In the present example, two electrophotographic photosensitive members A, B having photoconductive layers with different film thicknesses were prepared.

The pulse rectangular wave voltage to be applied was set to have frequency of 33 kHz, and pulse duty ratio on:off of 70%:30%. The pulse voltage shown in Table 1 is the value in pulse-on time.

Further in the present example, photosensitive members C, D were prepared applying pulse voltage as shown in Table 2, different from Table 1.

Still further, comparative examples were made by applying common RF electric power at 13.56 MHz. Under the conditions shown in Table 3, photosensitive members E, F, were made and under the conditions shown in Table 4, photosensitive members G, H were made by forming surface layers including second layers with different dilution rates of hydrogen.

TABLE 1

| | | Anti- | | | |
|---|---|---|---|---|---|
| | | charge | Photo- | Surface Layer | |
| | | Injection | conductive | First | Second |
| Layer | | Layer | Layer | Layer | Layer |
| Gas | SiH₄ (sccm) | 170 | 340 | 30 | 0.6 |
| Flow | B₂H₆* | 0.12% | 0.3 ppm | — | — |
| Amount | NO* | 10.0% | — | — | — |
| | CH₄ (sccm) | — | — | 600 | 600 |

| Gas Pressure (Pa) | | 60 | 60 | 80 | 80 |
|---|---|---|---|---|---|
| Board Temperature (° C.) | | 300 | 320 | 270 | 270 |
| Pulse Voltage (V) | | −950 | −1050 | −400 | −400 |
| Film | Photosensitive | 5.0 | 14.0 | 0.7 | 0.3 |
| Thickness | Member A | | | | |
| (μm) | Photosensitive | 5.0 | 24.0 | 0.7 | 0.3 |
| | Member B | | | | |

*proportion to the amount of SiH₄

TABLE 2

| | | Anti- | | | |
|---|---|---|---|---|---|
| | | charge | Photo- | Surface Layer | |
| | | Injection | conductive | First | Second |
| Layer | | Layer | Layer | Layer | Layer |
| Gas | SiH₄ (sccm) | 170 | 340 | 30 | 0.6 |
| Flow | B₂H₆* | 0.12% | 0.3 ppm | — | — |
| Amount | NO* | 10.0% | — | — | — |
| | CH₄ (sccm) | — | — | 600 | 600 |

| Gas Pressure (Pa) | | 60 | 60 | 80 | 80 |
|---|---|---|---|---|---|
| Board Temperature (° C.) | | 300 | 320 | 270 | 270 |
| Pulse Voltage (V) | | −450 | −450 | −400 | −400 |
| Film | Photosensitive | 5.0 | 14.0 | 0.7 | 0.3 |
| Thickness | Member C | | | | |
| (μm) | Photosensitive | 5.0 | 24.0 | 0.7 | 0.3 |
| | Member D | | | | |

*proportion to the amount of SiH₄

TABLE 3

| | | Anti- | | | |
|---|---|---|---|---|---|
| | | charge | Photo- | Surface Layer | |
| | | Injection | conductive | First | Second |
| Layer | | Layer | Layer | Layer | Layer |
| Gas | SiH₄ (sccm) | 130 | 300 | 30 | 0.6 |
| Flow | B₂H₆* | 0.16% | 0.7 ppm | — | — |
| Amount | NO* | 10.0% | — | — | — |
| | CH₄ (sccm) | — | — | 30 | 600 |
| | H₂ (sccm) | 100 | 300 | 60 | 35 |

| Gas Pressure (Pa) | | 60 | 60 | 80 | 80 |
|---|---|---|---|---|---|
| Board Temperature (° C.) | | 270 | 270 | 300 | 300 |
| High-Frequency Electric | | 135 | 300 | 150 | 150 |
| Power (W) | | | | | |
| Film | Photosensitive | 5.0 | 14.0 | 0.7 | 0.3 |
| Thickness | Member E | | | | |
| (μm) | Photosensitive | 5.0 | 24.0 | 0.7 | 0.3 |
| | Member F | | | | |

*proportion to the amount of SiH₄

TABLE 4

| | | Anti- | | | |
|---|---|---|---|---|---|
| | | charge | Photo- | Surface Layer | |
| | | Injection | conductive | First | Second |
| Layer | | Layer | Layer | Layer | Layer |
| Gas | SiH₄ (sccm) | 130 | 300 | 30 | 0.6 |
| Flow | B₂H₆* | 0.16% | 0.7 ppm | — | — |
| Amount | NO* | 10.0% | — | — | — |
| | CH₄ (sccm) | — | — | 30 | 600 |
| | H₂ (sccm) | 100 | 300 | 60 | 60 |

| Gas Pressure (Pa) | | 60 | 60 | 80 | 80 |
|---|---|---|---|---|---|
| Board Temperature (° C.) | | 270 | 270 | 300 | 300 |
| High-Frequency Electric | | 135 | 300 | 150 | 150 |
| Power (W) | | | | | |
| Film | Photosensitive | 5.0 | 14.0 | 0.7 | 0.3 |
| Thickness | Member G | | | | |
| (μm) | Photosensitive | 5.0 | 24.0 | 0.7 | 0.3 |
| | Member H | | | | |

*proportion to the amount of SiH₄

[Evaluation of Surface Roughness of Surface Layer]

The surface roughness of the surface layer was measured by AFM (“NanoScope” manufactured by Digital Instruments), and expressed in mean roughness Ra per 10 μm square and ten-point mean roughness Rz. Measurement results of the surface roughness of the surface layer are shown in the following Table 5, together with measurement results of surface roughness of an Al body which is not formed with deposited film.

[Evaluation of Composition of Surface Layer]

The composition of the surface layer was analyzed by XPS analysis (X-ray photoelectron spectroscopy analysis), and expressed in value X (carbon atom content). Measurement results of composition of the surface layer are shown in the following Table 5.

[Evaluation of Dynamic Indentation Hardness]

The dynamic indentation hardness was measured by a Dynamic Ultra Micro Hardness Tester (“DUH-201” manufactured by SHIMADZU CORPORATION). Measurement results are shown in the following Table 5.

[Evaluation of Wear Volume of Photosensitive Member]

In evaluation of wear volume of photosensitive member, each of the photosensitive members was incorporated in an electrophotographic printer (“KM-2550” manufactured by Kyocera Mita Corporation) for printing 10 thousand copies, and the thickness of the surface layer before and after the printing was measured by an optical interferometer. A difference between the measurement values before and after printing was evaluated. Measurement results of wear volume of photosensitive member are shown in the following Table 5.

[Evaluation of Image Deletion]

After printing 10 thousand copies, the electrophotographic printer is left under environment of high temperature and humidity (32° C., 85% RH) for 8 hours, and then image forming was performed for visually checking the generation of image deletion. Evaluation results of image deletion are shown in the following Table 5. In Table 5, the evaluation results were respectively indicated as “∘” when no image deletion was found, as “Δ” when a slight image deletion was found, and as “x” when any image deletion which may cause a practical problem was found.

TABLE 5

| | Surface Roughness | | | | | |
|---|---|---|---|---|---|---|
| | Measured by AFM | | Composition | Hardness | Wear | Image |
| Sample | Ra (nm) | Rz (nm) | (value X) | (kgf/mm²) | Volume (nm) | Deletion |
| Al Body | 1.37 | — | — | — | — | — |
| A | 5.51 | 28.4 | 0.95 | 350 | 1.5 | ∘ |
| B | 7.27 | 40.1 | 0.96 | 320 | 2.0 | ∘ |
| C | 5.92 | 34.6 | 0.96 | 380 | 1.5 | ∘ |
| D | 9.51 | 45.2 | 0.96 | 350 | 2.0 | ∘ |
| E | 14.63 | 73.0 | 0.96 | 80 | 14.0 | ∘ |
| F | 16.63 | 82.6 | 0.95 | 90 | 12.0 | ∘ |
| G | 14.12 | 72.5 | 0.96 | 250 | 2.0 | x |
| H | 15.59 | 76.3 | 0.96 | 270 | 2.0 | x |

### Example 2

In the present example, photosensitive members A′, D′, E′, F′ were made without forming the surface layers, under the same conditions as those of the photosensitive members A, D, E, F in Example 1, and surface roughness of the photoconductive layers was measured by AFM. Measurement results of the surface roughness of the photoconductive layers are shown in the following Table 6, together with the measurement results of the surface roughness of the surface layers in Example 1.

TABLE 6

Surface Roughness Measured by AFM

| Sample | Ra(nm) | Rz(nm) |
|---|---|---|
| A | 5.51 | 28.4 |
| A′ | 5.35 | 26.8 |
| D | 9.51 | 45.2 |
| D′ | 8.92 | 42.5 |
| E | 14.63 | 73.0 |
| E′ | 15.06 | 69.5 |
| F | 16.63 | 82.6 |
| F′ | 16.21 | 76.3 |

As can be seen from Table 6, the surface roughness of the photoconductive layers of the photosensitive members A′, D′, E′, F′ without surface layers is substantially the same as the surface roughness of the surface layers of the photosensitive members A, D, E, F. Thus, it can be said that each of the photosensitive members has the same roughness at the photoconductive layer and the surface layer, and when the surface roughness at the photoconductive layer is smaller than a predetermined value, the surface roughness at the surface layer formed on the photoconductive layer will be also small.

### Example 3

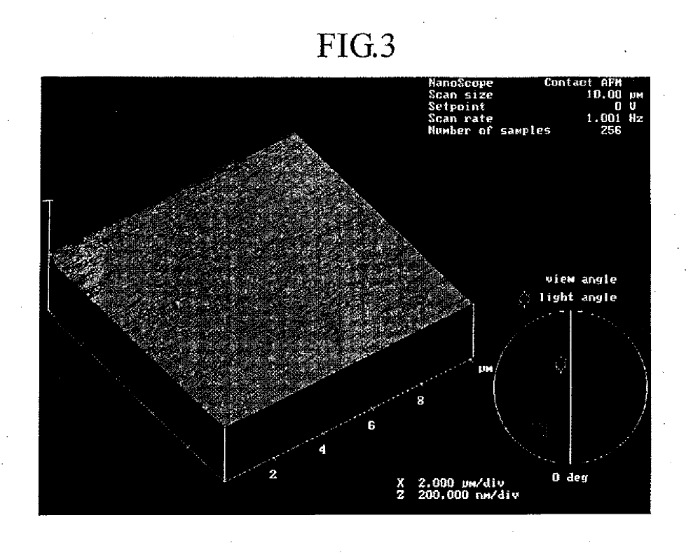

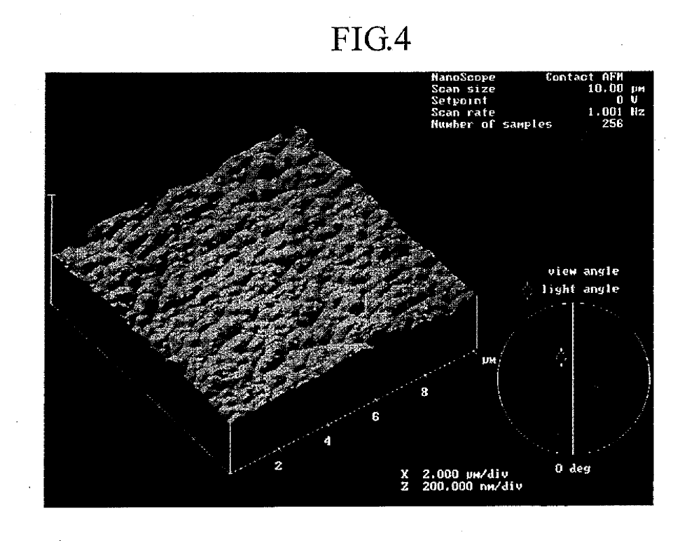

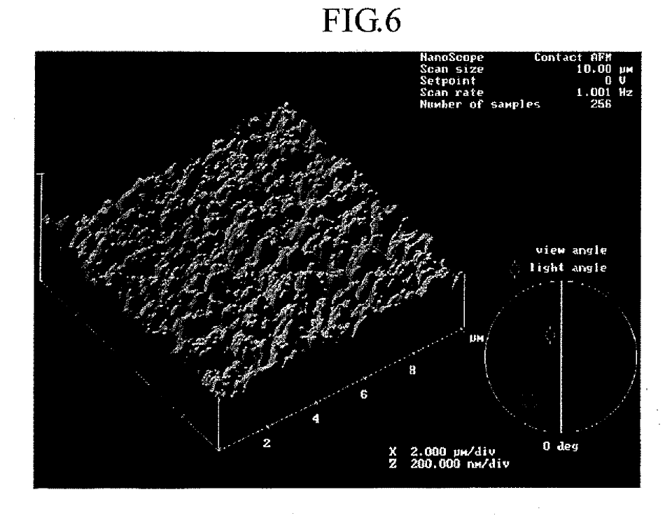

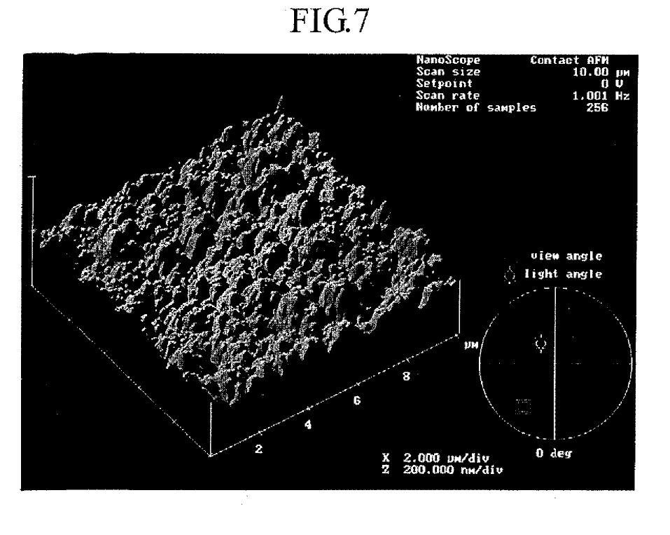

In present example, AFM photographs of the surfaces of a cylindrical body which is the same as the cylindrical bodies of the photosensitive members, and the surfaces of the photosensitive members A, D, E, F were taken. The AFM photographs were taken using “NanoScope” manufactured by Digital instrument. FIG. 3 shows the AFM photograph of the cylindrical body, and FIGS. 4 through 7 show the AFM photographs of the photosensitive members A, D, E, F, respectively. The photographs shown in FIGS. 3 through 7 are images in 10 μm square.

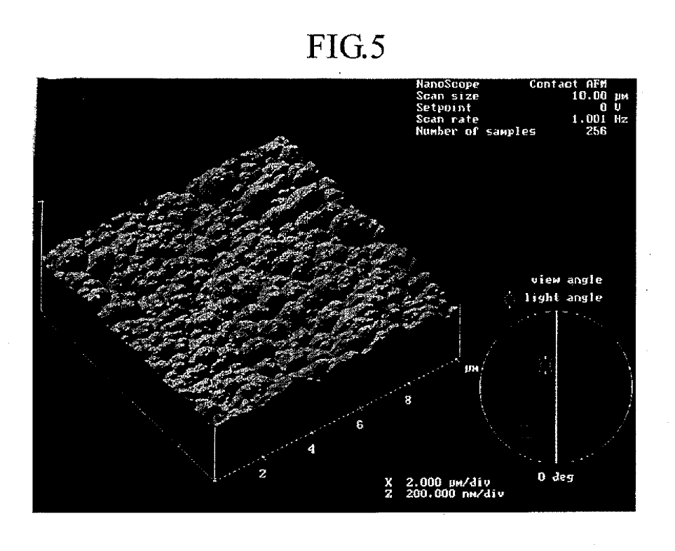

As can be seen from FIGS. 4 and 5, in the photosensitive members A, D, fine projections formed on the surfaces of the photosensitive members (surface layers) are smaller than those in the photosensitive members E, F. This may be considered due to ion sputtering effect in film forming. In the photosensitive members A, D, since the fine projections on the surface are relatively small, discharge products are unlikely to attach thereon, and discharge products entered into the concave portions on the surface are easily removed by the cleaning mechanism of the electrophotographic printer. This is the reason of the results in Example 1, in which, even having the surface layers with high hardness, the photosensitive members A, D, were capable of forming images of high quality without image deletion, under the environment of high temperature and humidity, after printing a number of copies.

### Example 4

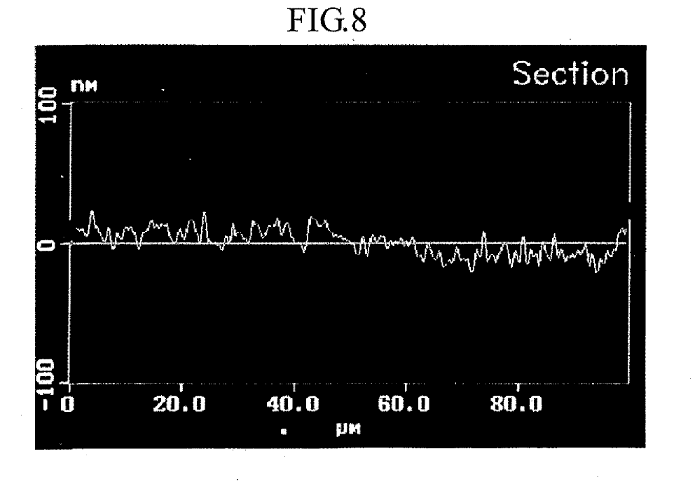

In the present example, profiles of surface roughness at the photosensitive members A, D, E, F were evaluated. The profiles of surface roughness were checked by the scanning probe microscope “NanoScope” manufactured by Digital Instruments. The profiles of surface roughness at the photosensitive members A, D, E, F are shown in FIGS. 8 through 11, respectively. These figures show the profiles in measurement length of 100 μm.

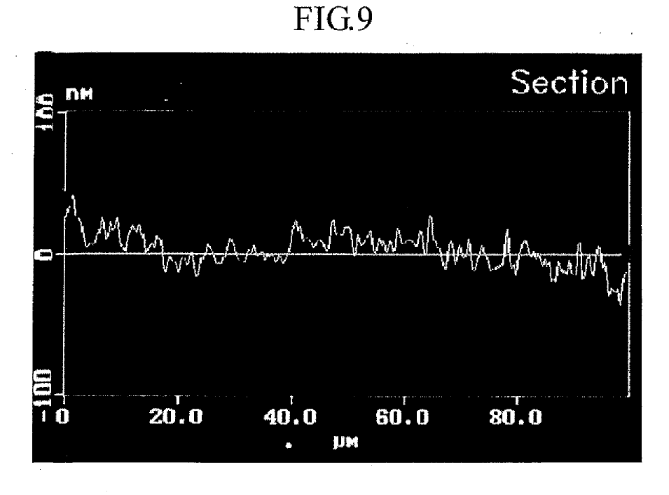

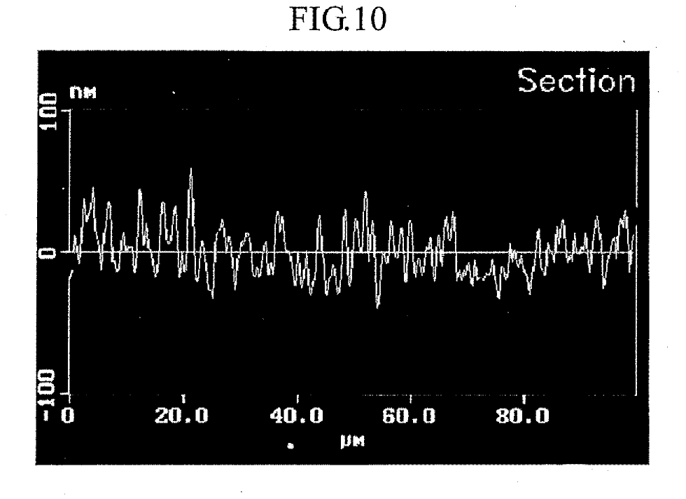

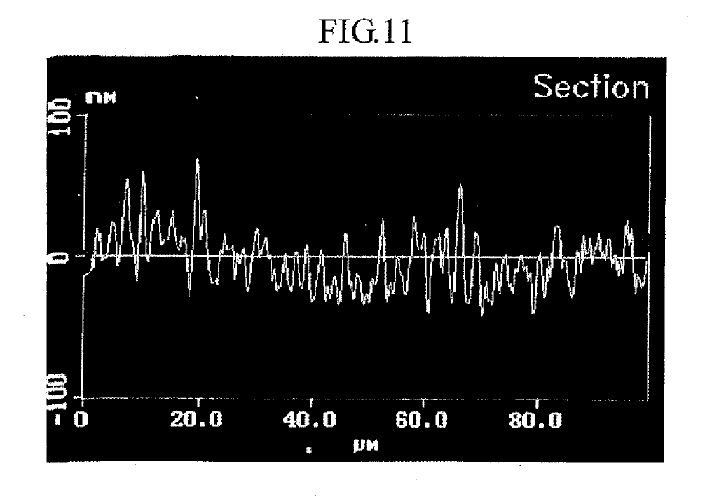

As can be seen from comparison between FIGS. 8, 9 showing the results at photosensitive members A, D and FIGS. 10, 11 showing the results at photosensitive members E, F, also with respect to profiles of surface roughness, the surfaces of the photosensitive members A, D have further enhanced smoothness than those of the photosensitive members E, F. Thus, discharge products are further easily removed from the photosensitive members A, D than from the photosensitive members E, F.

### Example 5

In the present example, evaluation was performed with respect to surface roughness at the photoconductive layer and the surface layer of each of the photosensitive members A, B, C, D, E, F, G, H. Each of the photosensitive members A, B, C, D, E, F, G, H was cut to take a cross-section photograph using the above-described FE-SEM, and surface roughness at each of the photoconductive layer and the surface layer as calculated in the above-described method. Measurement results of the surface roughness are shown in the following Table 7, together with the measurement results of the surface roughness measured by AFM in Example 1.

TABLE 7

| | Surface Roughness | | Surface Roughness | | Surface Roughness | |
|---|---|---|---|---|---|---|
| | at Surface Layer | | at Photoconductive Layer | | at Surface Layer | |
| | Measured by AFM | | Measured by FE-SEM | | Measured by FE-SEM | |
| Sample | Ra (nm) | Rz (nm) | Ra (nm) | Rz (nm) | Ra (nm) | Rz (nm) |
| A | 5.51 | 28.4 | 5.9 | 34 | 6.3 | 25 |
| B | 7.27 | 40.1 | 6.7 | 38 | 7.3 | 35 |
| C | 5.92 | 34.6 | 6.5 | 30 | 6.2 | 32 |
| D | 9.51 | 45.2 | 8.2 | 52 | 10.3 | 50 |
| E | 14.63 | 73.0 | 12.5 | 68 | 11.9 | 65 |
| F | 16.63 | 82.6 | 14.2 | 72 | 14.5 | 75 |
| G | 14.12 | 72.5 | 14.6 | 65 | 15.2 | 68 |
| H | 15.59 | 76.3 | 17.5 | 84 | 17.3 | 85 |

As can be seen from the results shown in Table 7, the surface roughness at the surface layer measured by AFM generally corresponds to the surface roughness at the photoconductive layer and the surface layer measured by FE-SEM. Further, as can be seen from Tables 5 and 7, when using FE-SEM, the evaluation results were similar to that when using AFM. Specifically, when the surface roughness at the photoconductive layer before forming the surface layer as well as at the surface of the photosensitive member after forming the surface layer is not more than 10 nm in Ra (not more than 50 nm in Rz), even the hardness is high, image of good quality was obtained under environment of high temperature and humidity, after printing a number of copies.

### Example 6

In the present example, after and during printing 300 thousand copies, image property and wear volume of the surface layer were evaluated.

A photosensitive member I made similarly to the photosensitive member A of the Example 1 was used. As a comparative example, a photosensitive member J made similarly to the photosensitive member E of the Example 1 was used.

The image property was evaluated by checking generation of image deletion and generation of streaks on a halftone image due to abraded portions of the photosensitive member. The wear volume of the surface layer was evaluated in the same way as the Example 1. Evaluation results of the image property and the wear volume of the surface layer are shown in the following Table 8.

The evaluation was performed during and after printing 300 thousand copies, since the photosensitive member having a cylindrical body with a diameter of about 30 mm is generally incorporated in an image forming apparatus of low speed and medium speed, and if usable until printing 300 thousand copies, it has adequate durability for practical use. Similar to the Example 1, the evaluation results of image deletion were respectively indicated as “∘” when no streak on a halftone image was found, as “Δ” when a slight streaks was found, and as “x” when a number of streaks was found.

TABLE 8

| | | Sample | | | | | |
|---|---|---|---|---|---|---|---|
| | | Present Photosensitive Member I | | | Comparative Photosensitive Member J | | |
| | | Evaluation Items | | | | | |
| | | Image | | Wear | Image | | Wear |
| | | Deletion | Streaks | Volume (nm) | Deletion | Streaks | Volume (nm) |
| Number | Beginning | ∘ | ∘ | 0 | ∘ | ∘ | 0 |
| of | 5,000 | ∘ | ∘ | 2 | ∘ | ∘ | 6 |
| Printing | 10,000 | ∘ | ∘ | 7 | ∘ | ∘ | 18 |
| | 50,000 | ∘ | ∘ | 35 | ∘ | ∘ | 82 |
| | 100,000 | ∘ | ∘ | 60 | ∘ | Δ | 150 |
| | 300,000 | ∘ | ∘ | 170 | ∘ | x | 430 |

As can be seen from the results shown in Table 8, in comparison with the comparative photosensitive member J, the present photosensitive member I forms good images of high quality without streaks in a halftone image, until printing 300 thousand copies. Further, the photosensitive member I had half as much wear volume as that of the photosensitive member J, while being used in a compact high-speed printer, which proves enhanced durability of the present photosensitive member.

1. An electrophotographic photosensitive member comprising a conductive body, a photoconductive layer formed on the conductive body using amorphous silicon, and a surface layer formed on the photoconductive layer using amorphous silicon,
wherein the photoconductive layer has a mean roughness Ra of not more than 10 nm per 10 μm square.

2. The electrophotographic photosensitive member according to claim 1, wherein the surface layer has a mean roughness Ra of not more than 10 nm per 10 μm square.

3. An electrophotographic photosensitive member comprising a conductive body, a photoconductive layer formed on the conductive body using amorphous silicon, and a surface layer formed on the photoconductive layer using amorphous silicon,
wherein the photoconductive layer has a ten-point mean roughness Rz of not more than 50 nm per measurement length of 100 μm.

4. The electrophotographic photosensitive member according to claim 3, wherein the surface layer has a ten-point mean roughness Rz of not more than 50 nm per measurement length of 100 μm.

5. An electrophotographic photosensitive member comprising a conductive body, a photoconductive layer formed on the conductive body using amorphous silicon, and a surface layer formed on the photoconductive layer using amorphous silicon,
wherein the photoconductive layer has a centerline mean roughness Ra(a) of not more than 10 nm, Ra(a) calculated from a boundary curve a between the photoconductive layer and the surface layer per measurement length of 2.5 μm, as seen in a cross-section photograph taken by a field emission scanning electron microscope.

6. The electrophotographic photosensitive member according to claim 5, wherein the surface layer has a centerline mean roughness Ra(b) of not more than 10 nm, Ra(b) calculated from a boundary curve b of the surface layer per measurement length of 2.5 μm, as seen in a cross-section photograph taken by a field emission scanning electron microscope.

7. An electrophotographic photosensitive member comprising a conductive body, a photoconductive layer formed on the conductive body using amorphous silicon, and a surface layer formed on the photoconductive layer using amorphous silicon,
wherein the photoconductive layer has a ten-point mean roughness Rz(a) of not more than 50 nm, Rz(a) calculated from a boundary curve a between the photoconductive layer and the surface layer per measurement length of 2.5 μm, as seen in a cross-section photograph taken by a field emission scanning electron microscope.

8. The electrophotographic photosensitive member according to claim 7, wherein the surface layer has a ten-point mean roughness Rz(b) of not more than 50 nm, Rz(b) calculated from a boundary curve b of the surface layer per measurement length of 2.5 μm, as seen in a cross-section photograph taken by a field emission scanning electron microscope.

9. An electrophotographic photosensitive member comprising a conductive body, a photoconductive layer formed on the conductive body using amorphous silicon, and a surface layer formed on the photoconductive layer using amorphous silicon,
wherein the surface layer has a mean roughness Ra of not more than 10 nm per 10 μm square, without undergoing grinding process.

10. An electrophotographic photosensitive member comprising a conductive body, a photoconductive layer formed on the conductive body using amorphous silicon, and a surface layer formed on the photoconductive layer using amorphous silicon,
wherein the surface layer has a ten-point mean roughness Rz of not more than 50 nm per measurement length of 100 μm, without undergoing grinding process.

11. An electrophotographic photosensitive member comprising a conductive body, a photoconductive layer formed on the conductive body using amorphous silicon, and a surface layer formed on the photoconductive layer using amorphous silicon,
wherein the surface layer, without undergoing grinding process, has a centerline mean roughness Ra(b) of not more than 10 nm, Ra(b) calculated from a boundary curve b of the surface layer per measurement length of 2.5 μm, as seen in a cross-section photograph taken by a field emission scanning electron microscope.

12. An electrophotographic photosensitive member comprising a conductive body, a photoconductive layer formed on the conductive body using amorphous silicon, and a surface layer formed on the photoconductive layer using amorphous silicon,
wherein the surface layer, without undergoing grinding process, has a ten-point mean roughness Rz(b) of not more than 50 nm, Rz(b) calculated from a boundary curve b of the surface layer per measurement length of 2.5 μm, as seen in a cross-section photograph taken by a field emission scanning electron microscope.

13. An image forming apparatus comprising t a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the photoconductive layer has a mean roughness Ra of not more than 10 nm per 10 μm square.

14. The image forming apparatus according to claim 13, wherein the surface layer has a mean roughness Ra of not more than 10 nm per 10 μm square.

15. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the photoconductive layer has a ten-point mean roughness Rz of not more than 50 nm per measurement length of 100 μm.

16. The image forming apparatus according to claim 15, wherein the surface layer has a ten-point mean roughness Rz of not more than 50 nm per measurement length of 100 μm.

17. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the photoconductive layer has a centerline mean roughness Ra(a) of not more than 10 nm, Ra(a) calculated from a boundary curve a between the photoconductive layer and the surface layer per measurement length of 2.5 μm, as seen in a cross-section photograph taken by a field emission scanning electron microscope.

18. The image forming apparatus according to claim 17, wherein the surface layer has a centerline mean roughness Ra(b) of not more than 10 nm, Ra(b) calculated from a boundary curve b of the surface layer per measurement length of 2.5 μm, as seen in a cross-section photograph taken by a field emission scanning electron microscope.

19. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the photoconductive layer has a ten-point mean roughness Rz(a) of not more than 50 nm, Rz(a) calculated from a boundary curve a between the photoconductive layer and the surface layer per measurement length of 2.5 μm, as seen in a cross-section photograph taken by a field emission scanning electron microscope.

20. The image forming apparatus according to claim 19, wherein the surface layer has a ten-point mean roughness Rz(b) of not more than 50 nm, Rz(b) calculated from a boundary curve b of the surface layer per measurement length of 2.5 μm, as seen in a cross-section photograph taken by a field emission scanning electron microscope.

21. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the surface layer has a mean roughness Ra of not more than 10 nm per 10 μm square, without undergoing grinding process.

22. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the surface layer has a ten-point mean roughness Rz of not more than 50 nm per measurement length of 100 μm, without undergoing grinding process.

23. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the surface layer, without undergoing grinding process, has a centerline mean roughness Ra(b) of not more than 10 nm, Ra(b) calculated from a boundary curve b of the surface layer per measurement length of 2.5 μm, as seen in a cross-section photograph taken by a field emission scanning electron microscope.

24. An image forming apparatus comprising a electrophotographic photosensitive member,
the electrophotographic photosensitive member having a conductive body, a photoconductive layer formed on the conductive body using amorphous silicon, and a surface layer formed on the photoconductive layer using amorphous silicon,
wherein the surface layer, without undergoing grinding process, has a ten-point mean roughness Rz(b) of not more than 50 nm, Rz(b) calculated from a boundary curve b of the surface layer per measurement length of 2.5 μm, as seen in a cross-section photograph taken by a field emission scanning electron microscope.
